(19) United States
(12) Patent Application Publication
(10) Pub. No.: US 2022/0324249 A1
(43) Pub. Date: Oct. 13, 2022

(54) Restaurant and Nightclub Bill Receipt Reader Systems

(71) Applicant: David Wesley Olivas, Miami Beach, FL (US)

(72) Inventor: David Wesley Olivas, Miami Beach, FL (US)

(21) Appl. No.: 17/853,111

(22) Filed: Jun. 29, 2022

Related U.S. Application Data
(60) Provisional application No. 63/215,999, filed on Jun. 29, 2021.

(51) Int. Cl. B42F 9/00; F21L 4/08; F21V 23/04

(52) U.S. Cl. CPC B42F 9/004; F21L 4/08; F21V 23/0414; F21Y 2115/10

(57) ABSTRACT

A system suitable for use as a restaurant and nightclub receipt reader is provided. The system includes a translucent plate. The system also includes a light emitting diode (LED) configured to provide illuminating light into the translucent plate. The system further includes a battery designed to provide power to the LED. The system includes an on/off switch arranged to turn the LED on and off. The system also includes a clip positionable on a top upper front side of the translucent plate and structured to be utilized to retain a receipt against the front side of the translucent plate allowing a user of the system to effectively view the receipt in low ambient light conditions. Additionally, the system is configured wherein the LED, the battery, the on/off switch, and associated control circuitry for controlling the LED are located under a bottom surface of the clip.

### RELATED APPLICATIONS

This application claims priority to Provisional Application No. 63/215,999 filed Jun. 29, 2021. The entire contents of the above application are hereby incorporated by reference as though fully set forth herein.

### FIELD OF THE INVENTION

The present invention relates generally to bill receipt readers, and more particularly, to restaurant and nightclub bill receipt reader systems, which utilize Light Emitter Diodes (LEDs) to illuminate an acrylic board with a reflective back to allow bill receipts to be read in low ambient light conditions.

### BACKGROUND OF THE INVENTION

Many methods and devices have been unsuccessfully attempted to efficiently and effectively provide illumination devices to read bill receipts in low light conditions which can be utilized in any location. Several devices, systems, and methods have been created and implemented to address the problem of having a bill receipt presented to nightclub or restaurant patrons for review and payment in low light conditions. However, those efforts often resulted in increased costs due to the complex components needed to be added to common bill receipt holders in order to provide adequate light to read the bill receipt. Further, many of the previous lighting attempts often were a nuisance to others in the vicinity due to the introduction of additional bright lighting sources required to see the bill receipt. Often, these additional lighting sources would cause others in the vicinity to momentarily lose their ability to see around them and lose their own situational awareness. This also caused safety concerns.

Previous add on lighting devices rendered the bill presentation by a server to a patron awkward due to the bulkiness of the components added to the bill receipt holder. These previous add-on devices often were put together with ineffective components and resulted in additional costs.

Other unsuccessful attempts to provide adequate lighting to read a receipt in low light conditions often required expensive components to be added to standard receipt holders. These efforts resulted in increased costs.

Often, in low lighting conditions, an external light such as a flashlight or a cell phone flashlight would be used to illuminate a bill. This additional light source is cumbersome and quite often would disturb others around the person trying to read their bill.

Accordingly, there is an established need for bill receipt readers which solve at least one of the aforementioned problems. Further, there is an established need for restaurant and nightclub bill receipt readers which can be utilized more efficiently and effectively and provide servers and patrons with ergonomically designed bill receipt readers which can be read in low light condition, is economical, and subsequently to allow increased work production and reduce safety hazards.

### SUMMARY OF THE INVENTION

The present invention is directed to innovative and cost-effective bill receipt readers which can be used by restaurants, bars, nightclubs, movie theaters and in other areas where low ambient light conditions exist. Further, this invention can be directed for use for end users that are visually challenged and therefore can utilize the present invention to adequately read their bill.

In an aspect, A system suitable for use as a restaurant and nightclub receipt reader is provided. The system includes a translucent plate. The system also includes a light reflecting layer positioned on a bottom side of the translucent plate. The system also includes a light emitting diode (LED) configured to provide illuminating light into the translucent plate. The system further includes a battery designed to provide power to the LED. The system includes an on/off switch arranged to turn the LED on and off. The system also includes a clip positionable on a top upper front side of the translucent plate and structured to be utilized to retain a receipt against the front side of the translucent plate allowing a user of the system to effectively view the receipt in low ambient light conditions. Additionally, the system is configured wherein the LED, the battery, the on/off switch, and associated control circuitry for controlling the LED are compactly located under a bottom surface of the clip and positioned for a system user to turn the system on and off from a back side area of the clip.

In another aspect, a system suitable for use as a restaurant and nightclub receipt reader system is provided. The system consists solely of the following components: a translucent plate. The system also includes a light reflecting layer positioned on a bottom side of the translucent plate. The system includes a light emitting diode (LED) configured to provide illuminating light into the translucent plate. The system also includes a battery designed to provide power to the LED. Further, the system includes an on/off switch arranged to turn the LED on and off. The system includes an LED dimmer switch configured to adjust light emitted from the LED. The system also includes a battery charging connection configured to allow charging the battery with an external power source connected to the battery charging connection. The system further includes a clip positionable on a top upper front side of the translucent plate and structured to be utilized to retain a receipt against the front side of the translucent plate allowing a user of the system to effectively view the receipt in low ambient light conditions. The system is further configured wherein the LED, the battery, the on/off switch, the LED dimmer switch, battery charging connection, and associated control circuitry for controlling the LED are compactly located under a bottom surface of the clip and positioned for a system user to turn the system on and off from a back side area of the clip.

In embodiments, the system can include an acrylic board with reflective tape on a backside of the board, a clip on a front side of the board, and housed under the clip at least one light emitting diode (LED) and a battery to power the LED.

In embodiments, the system can include a charging module. The charging module can include a battery overcharge and over-current protection. There can be a red-light indicating charging and a blue light when fully charged. Further, the system can work while charging. Also the components for the LED may be on the back and sides for control but it is possible for them to be on the top, on the power button or another control device.

In embodiments, the system can solely include a compact system consisting of a translucent plate, reflective backing on the plate, a clip on an upper top side of the plate, and housed underneath the clip an LED to illuminate the translucent plate, dim controller to control light emission from the LED, battery to power the LED, and a battery charging connection. In embodiments, these components alone provide all the necessary working components for an efficient and cost-effective system without additional components which would be more costly and bulkier.

In embodiments, the system can include small compact dimensions configured to allow the system to fit in a shirt or pants pocket.

In embodiments, the system can include water resistant surfaces allowing the system to function in wet environments.

In embodiments, the system can include light charging panels, these panels can be similar in construction to solar panels however are designed to generate charging voltage and current from indoor lighting. In embodiments, charging panels would be positioned on top of the clip of the system and would allow charging of the system battery while the system is not in use and is kept under an indoor light

In embodiments, the LED can also be directed into a substrate of the acrylic board allowing the acrylic board to provide a light source. The light source can further be controlled by a dimmer switch in order to adjust to ambient lighting conditions.

In embodiments, the LED can be directed onto a surface of the acrylic board.

In embodiments, the system can also include touch sensors, the touch sensors configured to turn the LED on or off.

In embodiments, the system can include a plurality of LEDs.

In embodiments, the system can include a plurality of batteries.

In embodiments, the system can include a universal serial bus (USB) charger for charging a battery or a plurality of batteries. Further, the system can also include a micro-USB charger for charging a battery or a plurality of batteries.

In embodiments, the system can include a lithium rechargeable battery.

In embodiments, the system can include a lithium-ion polymer (lipo) battery.

In embodiments, the system can include customizable reflective backing in that a thickness and reflective index can be varied.

In embodiments, the system can include system components, other than the acrylic board and reflective backing, to be compacted behind the clip.

In embodiments, the system can include a female micro-USB charging board.

In embodiments, the system can include reflective tape or reflective board which can further include a plurality of colors, such as but not limited to white, red, green, or blue.

In embodiments, the system can include LEDs which can include a plurality of colors, such as but not limited to white, red, green, or blue.

In embodiments, the system can include engravings onto a top surface of the acrylic board such that upon illumination the engravings would be accentuated.

These and other objects, features, and advantages of the present invention will become more apparent from the attached drawings and the detailed description of the preferred embodiments, which follow. It is understood that the drawings are designed for the purposes of illustration and not as a definition of the limits of the embodiments of the present invention. It should be further understood that the drawings are not necessarily drawn to scale and are merely intended to conceptually illustrate the methods and systems described herein.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a top of view of a system, in accordance with an embodiment of the present invention;

FIG. 2 presents a back side view of an embodiment of the present invention;

FIG. 3 presents a left-hand side view of an embodiment of the present invention;

FIG. 4 presents a front side view of an embodiment of the present invention; and

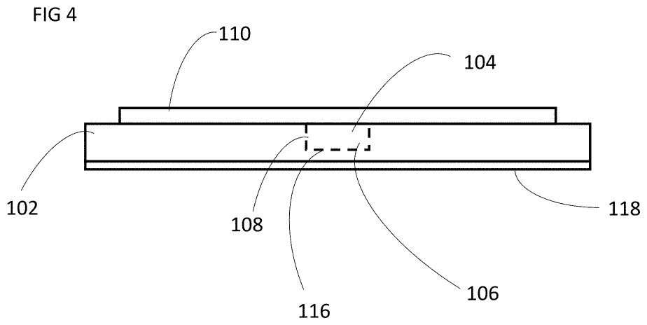

FIGS. 5A and 5B present top perspective exploded views of an assembled system in accordance with an embodiment of the present system.

### DETAILED DESCRIPTION

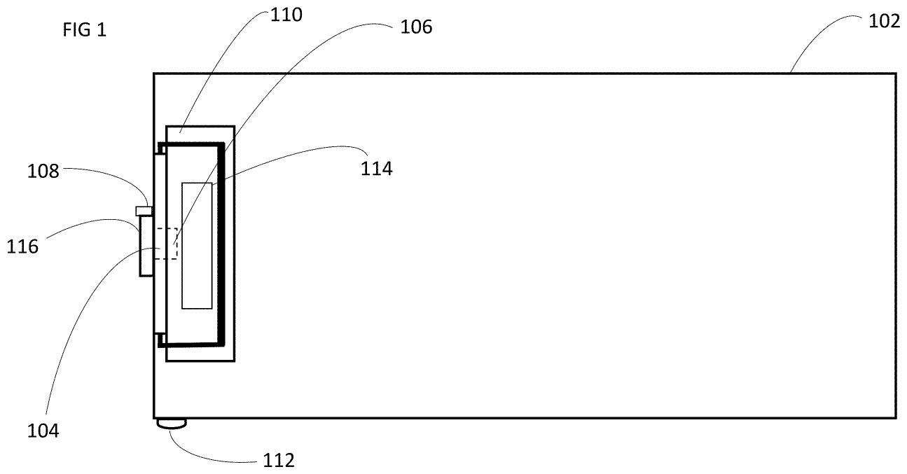

The following detailed description is exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

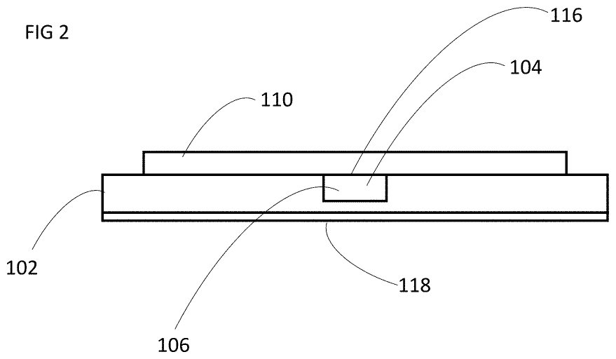

Referring initially to FIG. 1, a top view of the system 100 is presented. The system can include a translucent plate 102. A clip 110 can be positioned on an upper top side surface of the plate 102. As best seen in FIG. 2 a light reflecting layer118 can be positioned on a bottom side of the plate 102. On a top surface of the clip 110 a plurality of charging panels 114 can be placed. The charging panels 114 can generate charging energy for system 100 battery 116 with exposure to sunlight or internal light sources. The system 100 also include a dimmer switch 112 configured to control the intensity of light emitted by the system 100 LED 104. The charging connection 116, the battery 106, on/off switch 108, and associated control and electrical power circuitry can be compactly located under a surface of the clip 110.

Turning to FIG. 2, a side view of a system shows a clip 110 on an upper top side of an acrylic board or translucent plate 102. As best seen in FIG. 2, all system components, charging connection 116, LED 104, on/off switch 108, dimmer switch 112, battery 106 other than the clip and board, can be placed under the clip 110. The acrylic board has a reflective backing 118 on a side opposite of the clip 110.

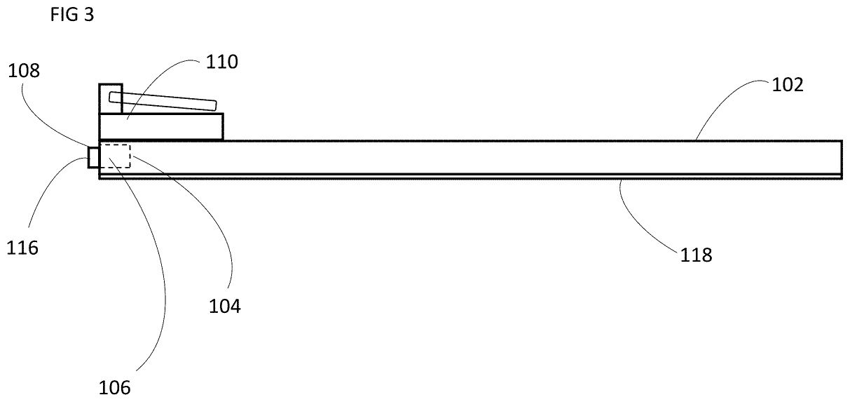

FIG. 3 is a side view of a system 100. As shown, the system includes a clip 110, a board 102, a battery 106, charging connection 116, LED 104, on/off switch 108, dimmer switch 112 and control module and control circuitry. Further, on a backside of the acrylic board 102 is a reflective backing 118.

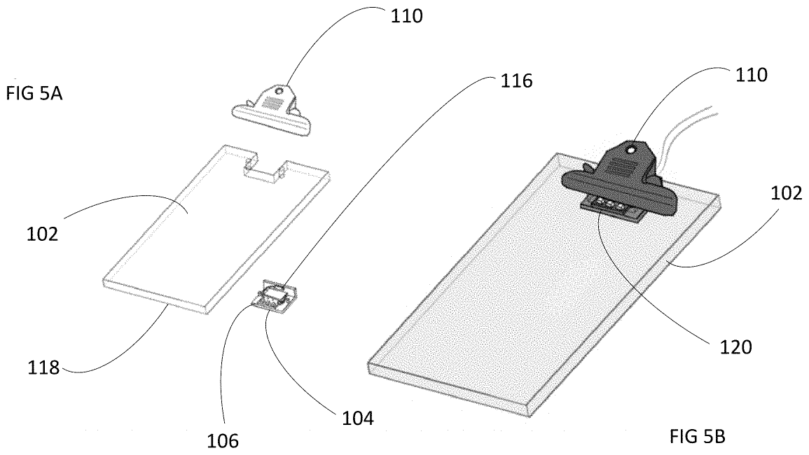

FIG. 5A shows a back side view of a system 100 with the battery 106, LED 104, on/off switch 108, dimmer switch 112, charging connection 116 and control module compacted under the clip 110.

As best seen in FIG. 5B, the system 100 can include embodiments wherein the dimmer switch 112, LED 104, charging connection 116, battery 106, on/off switch 108 can be aggregately combined into a control module 120 and positioned under the clip 110.

In embodiments not shown, the system 100 can include a unitary formed cover over all system components to allow increased water resistance.

In embodiments not shown, the system 100 can include solar panels configured to allow charging of the system 100 while placed in sunlight.

In an embodiment, the system can include an acrylic board, a metal clipboard clip, 1 LED, 1 adjustable potentiometer on/off switch, 100 mAh lipo battery, a female micro USB charging board, and a reflective plate. The battery, charging port, LED and potentiometer are assembled and inserted into a space inside the acrylic board under the clip and the switch and charger are at the top of the board. Further, the reflective plate is placed on an underside of the acrylic board inline where a receipt would be placed.

While the foregoing written description of the exemplary embodiments enables one of ordinary skill to make and use what is considered presently to be the best mode thereof, those of ordinary skill will understand and appreciate the existence of variations, combinations, and equivalents of the specific embodiment, method, and examples herein. The exemplary embodiments should therefore not be limited by the above-described embodiment, method and examples, but all embodiments and methods within the scope and spirit of the exemplary embodiments as claimed.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized the scope of this invention is much broader than presented by the claims. It is intended that broader claims will be submitted in an application that claims the benefit of priority from this application.

What is claimed is:

1. A system suitable for use as a restaurant and nightclub receipt reader system comprising:
a translucent plate;
a light reflecting layer positioned on a bottom side of the translucent plate;
a light emitting diode (LED) configured to provide illuminating light into the translucent plate;
a battery designed to provide power to the LED;
an on/off switch arranged to turn the LED on and off;
a clip positionable on a top upper front side of the translucent plate and structured to be utilized to retain a receipt against the front side of the translucent plate allowing a user of the system to effectively view the receipt in low ambient light conditions; and
wherein the LED, the battery, the on/off switch, and associated control circuitry for controlling the LED are compactly located under a bottom surface of the clip and positioned for a system user to turn the system on and off from a back side area of the clip.

2. The system of claim 1 further comprising a dimmer switch configured to adjust light emitted from the LED.

3. The system of claim 1 further comprising a battery charging connection configured to allow charging the battery with an external power connected to the battery charging connection.

4. The system of claim 1 further comprising battery charging light panels located on a top surface of the clip and configured to allow for charging of the battery while the system is not in operation and the system is stored under a light source.

5. A system suitable for use as a restaurant and nightclub receipt reader system consisting solely of the elements:
a translucent plate;
a light reflecting layer positioned on a bottom side of the translucent plate;
a light emitting diode (LED) configured to provide illuminating light into the translucent plate;
a battery designed to provide power to the LED;
an on/off switch arranged to turn the LED on and off;
an LED dimmer switch configured to adjust light emitted from the LED;
a battery charging connection configured to allow charging the battery with an external power source connected to the battery charging connection;
a clip positionable on a top upper front side of the translucent plate and structured to be utilized to retain a receipt against the front side of the translucent plate allowing a user of the system to effectively view the receipt in low ambient light conditions; and
wherein the LED, the battery, the on/off switch, the LED dimmer switch, battery charging connection, and associated control and power circuitry for controlling the LED are compactly located under a bottom surface of the clip and positioned for a system user to turn the system on and off from a back side area of the clip.
